(19) United States
(12) Patent Application Publication
(10) Pub. No.: US 2005/0181326 A1
(43) Pub. Date: Aug. 18, 2005

(54) Powered handpiece for dental or surgical use

(75) Inventor: Luc Maitre, Epauvillers (CH)

Correspondence Address: SUGHRUE MION, PLLC, 2100 PENNSYLVANIA AVENUE, N.W., SUITE 800, WASHINGTON, DC, 20037, US

(73) Assignee: BIEN-AIR HOLDING S.A.

(21) Appl. No.: 11/045,098

(22) Filed: Jan. 31, 2005

(30) Foreign Application Priority Data
Feb. 17, 2004 (EP) 04003518.0

(51) Int. Cl. A61C 3/00

(52) U.S. Cl. 433/114

(57) ABSTRACT

The handpiece (1) has a clamp (10) at the front, which is arranged to tightly grip the shank of a tool and is mounted in a hollow rotatable shaft (11). This is entrained by an electric motor (13), the shaft (12) of which is disposed in the extension of the hollow shaft (11), the adjacent ends of these two shafts being rotatably connected by a positive coupling (61). The adjacent ends of the two shafts (11, 12) are both supported by the same inner ring (63) of a central bearing (15). The coupling (61) is located inside said inner ring (63), in which the end of the shaft of the motor is slidingly mounted and is loaded axially by a spring (69).

This application claims priority from European Patent Application No. 04003518.0 filed Feb. 17, 2004, the entire disclosure of which is incorporated herein by reference.

### BACKGROUND OF THE INVENTION

The present invention relates to a powered handpiece for dental or surgical use of the type comprising: a hollow shaft, which is rotatable around a longitudinal axis and mounted by bearings in a fixed tubular sheath; a clamp mounted in a front end of the hollow shaft and having a central channel intended to receive the shank of a removable tool, the clamp having axial arms arranged around said axis, each of which being provided with a gripping jaw in the central channel; a tightening mechanism supported by the hollow shaft and arranged to exert a centripetal force on a supporting surface of each arm of the clamp to grip the tool shank between the gripping jaws of the clamp; and a motor, the shaft of which is disposed in the extension of the hollow shaft, the adjacent ends of these two shafts being rotatably connected by a positive coupling.

A powered handpiece of this type is known, for example, from patent application EP 670 149. The hollow shaft supporting the clamp is mounted by two bearings in a structure of the front section of the handpiece, while the shaft of the electric motor is supported by two other bearings in a structure of the rear section. The two structures are fitted together end to end and screwed to one another in a central region of the handpiece, where the two coaxial shafts are fitted together end to end. A construction of the same type with a pneumatic motor is illustrated in FIGS. 2 to 5 in patent application U.S. 2002/0151902 A1.

A first disadvantage of this construction lies in its length, which is particularly inconvenient in the case of a handpiece containing an electric motor, which is quite heavy to the rear of the hand of the user. Another disadvantage that is even more inconvenient lies in the difficulty of attaining a good concentricity and good alignment of the two shafts. Any error in this regard will inevitably result in vibrations and noise at the high rotational speeds which are reached with this type of instrument.

### SUMMARY OF THE INVENTION

The present invention aims to avoid the above-mentioned disadvantages of the prior art on the basis of an arrangement, which allows the arrangement of the bearings of the handpiece to be simplified and a more compact construction subjected less to vibrations to be obtained. An additional aim is to obtain axial prestresses that are advantageously distributed on the bearings.

On this basis, a powered handpiece of the type indicated in the above introduction is provided, characterised in that the adjacent ends of the two shafts are both supported by the same inner ring of a central bearing. The coupling can advantageously be located inside the inner ring of the central bearing.

Thus, the invention allows the whole rotating section of the powered handpiece to be mounted on only three bearings, while retaining a coupling which permits a certain axial play between the shaft of the motor and the shaft supporting the clamp and the tool, which are aligned coaxially.

Thus, the two shafts are always kept perfectly concentric in the region of their coupling, and it is precisely in this region that they are centred by the inner ring of the central bearing. Even if there were a small error in alignment of the two shafts, i.e. a slight angle between their axes, no vibrations would result.

According to an advantageous embodiment, a first prestressing spring is arranged to apply a continuous axial stress on the hollow shaft via the bearing supporting this shaft at the front, while a second prestressing spring is disposed between the two shafts in the region of the coupling and is fitted to transfer an axial stress from one to the other, which is lower than that of the first spring so that the difference between these axial stresses is transferred onto the central bearing, while the stress of the second spring serves to prestress the third bearing.

Other features and advantages of the present invention may be seen from the following description of various embodiments presented by non-restrictive example with reference to the attached drawings.

### BRIEF DESCRIPTION OF THE DRAWINGS

FIG. 1 is a schematic perspective view of a handpiece according to the invention;

FIG. 2, divided in two sections 2(a) and 2(b), is a view in longitudinal section of a first embodiment of the handpiece according to FIG. 1, comprising a clamp connected to a ball-type tightening mechanism;

FIGS. 3 to 5 show the clamp seen in FIG. 2 in perspective, in longitudinal section and in side view respectively;

FIG. 6 is a partial perspective view of a control device for gripping the clamp;

FIG. 7 is a view of the coupling between the two shafts of the handpiece;

FIG. 8 shows an intermediate part of the coupling;

FIG. 9 is a detail view in longitudinal section showing a second embodiment resulting from a modification of the ball-type tightening mechanism shown in FIG. 2.

### DETAILED DESCRIPTION OF EMBODIMENTS OF THE INVENTION

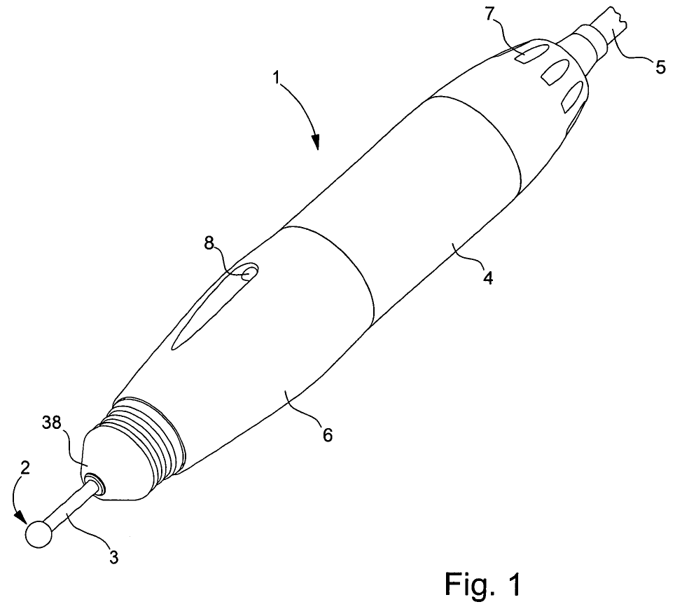

FIG. 1 shows a handpiece 1 for dental or surgical use, in which various embodiments of the invention may be seen, which will be described further below. The handpiece is fitted with a removable rotatable tool 2 with a cylindrical shank 3, which is gripped in a rotatable clamp of handpiece 1. This contains a motor, i.e. an electric motor, to cause tool 2 to rotate at high speed. The motor is housed in the main body 4 of the handpiece and is supplied with power and controlled from an external unit via an electric cable 5 connected to the rear of the handpiece. The operator controls the tightening and release of the clamp by causing a sleeve 6 rotatably mounted on body 4 to rotate in one direction or the other. References 7 and 8 refer to vents. Such an instrument finds application in particular in dental practices, dental laboratories and in microsurgical techniques. In the examples shown here, it is an instrument for a dental laboratory using tools having a shank with a standard diameter of 2.35 mm.

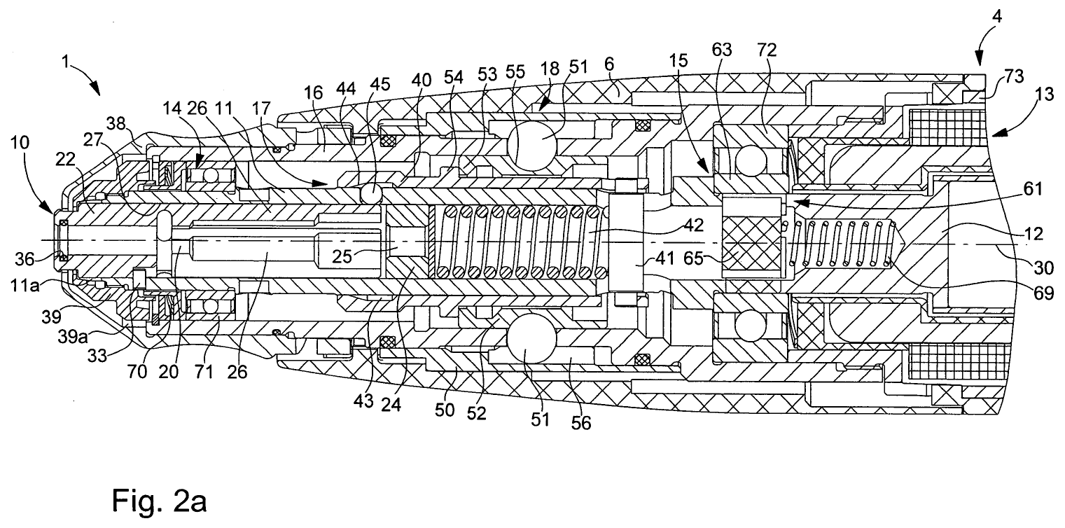

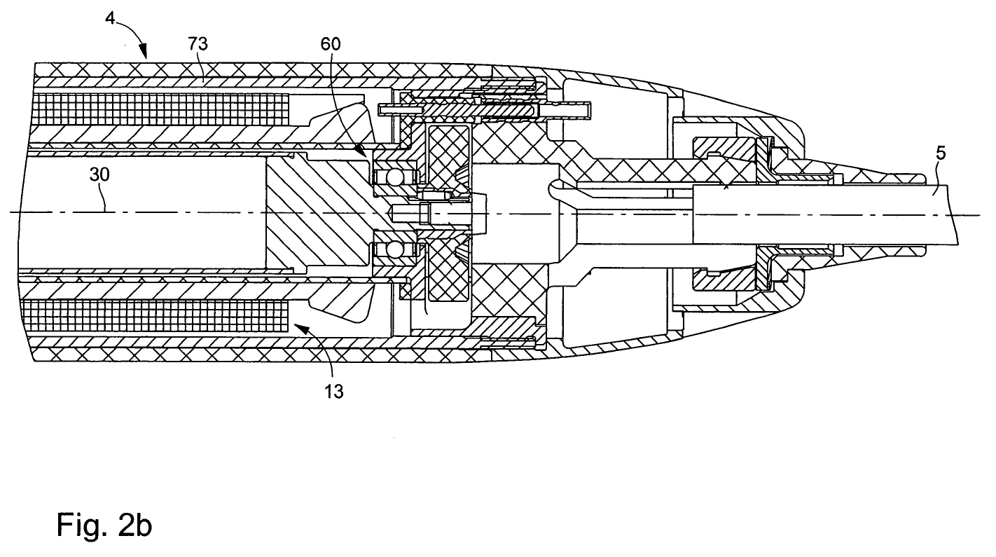

A first embodiment of a clamp 10 for gripping the tool and of the tightening and release mechanisms of this clamp shall now be described with reference to FIGS. 2 to 5. Clamp 10 is located in the front end of the handpiece inside a hollow rotatable shaft 11 coupled to shaft 12 of the electric motor 13. Shaft 11 is supported by ball bearings 14 and 15 in a sheath 16 fixed to body 4 of the handpiece, and it can thus rotate at speeds in the order to 50 000 revs/minute in the instrument shown here. However, a gripping clamp such as clamp 10 may also be used in instruments, in which the tool can rotate several hundreds of thousands revs. per minute, in particular with an air turbine drive.

A mechanism 17 for tightening clamp 10 is mounted on shaft 11 and rotates with it. A mechanism 18 for releasing the clamp, which is controlled by the rotation of sleeve 7, is mounted on the non-rotatable sheath 16 and can act on tightening mechanism 17 in order to free the tool when the rotation has stopped. These mechanisms will be described in detail below.

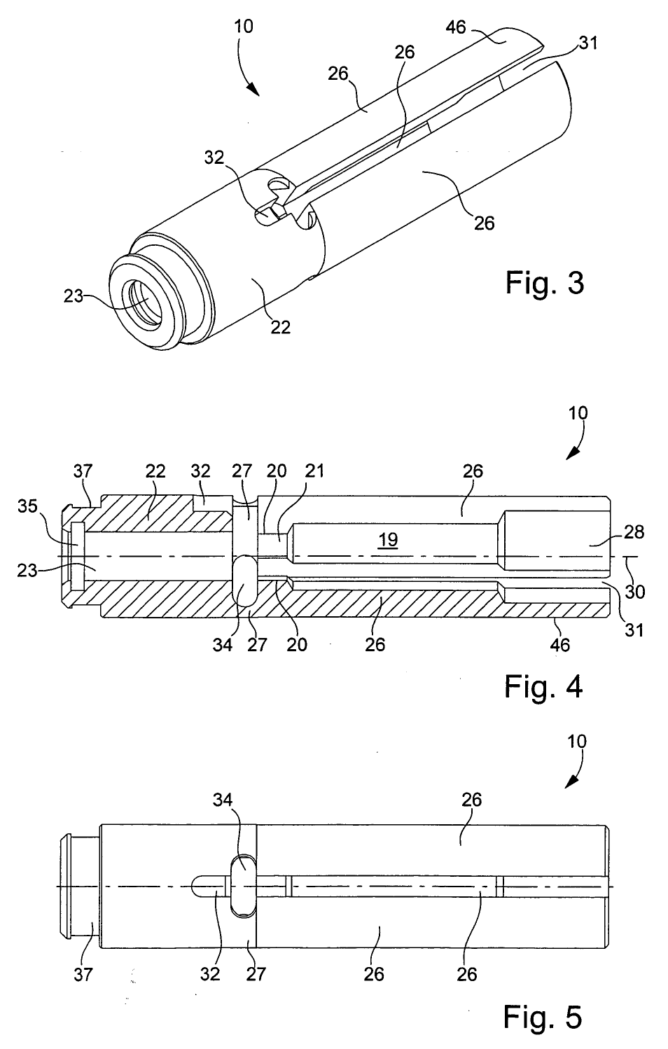

FIGS. 3 to 5 more particularly show the first embodiment of clamp 10, which in this case has three gripping jaws 20 uniformly distributed around a central channel 19 of the clamp to receive tool shank 3. Each gripping jaw 20 has a cylindrical surface portion 21 intended to engage against the tool shank.

At the front, clamp 10 has an essentially cylindrical entry tube 22 provided with an axial hole 23 calibrated to high precision in order to centre the tool as perfectly as possible. It will be seen from FIG. 2 that a rear guide tube 24 is fixed in shaft 11 at the rear of clamp 10 and has a central hole 25 intended to guide the end of the tool shank.

Each gripping jaw 20 forms an integral part of a respective lever 26, which extends axially towards the rear from tube 22, to which it is attached by a flexible part 27 forming a joint, as it were, on which lever 26 can pivot in the direction of the axis of rotation 30 of the shaft. On each lever 26, gripping jaw 20 is located much closer to flexible part 27 than to a free end 28 of the lever, so that a radial force applied to the lever close to its end 28 produces a very high gripping force at the level of gripping jaw 20.

The clamp 10 shown in the drawings is preferably made from a single piece of metal, e.g. steel. Levers 26 are separated from one another by axial slits 31, each continuing via a slot 32 into the rear of tube 22. A pin 33, which rotatably holds clamp 10 and hollow shaft 11, engages into each slot 32. Transverse slits 34 reduce the thickness of the levers 26 at their base and thus define flexible parts 27 in three peripheral regions of the cross-section of the clamp. At the front of entry tube 22, an inner annular groove 35 is provided for an O ring 36 and an outer annular groove 37 for the lips of a fixed cap 38 and a screw 39 screwed into shaft 11 to axially hold clamp 10. Screw 39 is provided with ventilation fins 39a intended to create a slight pressure of air under cap 38 in order to prevent contaminants from entering through the slit between the cap and tube 22. In addition, screw 39 radially tightens end 11a of hollow shaft 11 against tube 22, this end being thin and divided into flexible tabs by axial slits. This ensures that clamp 10 is centred without play in the hollow shaft.

In a variant not shown here, entry tube 22 can be a separate piece that does not form part of clamp 10. The front of said clamp is then formed by a short annular section, to which levers 26 are attached by a joint. This annular section can be a separate piece from the levers, where required, but a configuration in one piece is generally preferred.

Tightening mechanism 17 has a sleeve 40, which is mounted to slide around hollow shaft 11, with which it is rotatably held by a cross bar 41 engaged in longitudinal slits of shaft 11 and sleeve 40. A compression spring 42 resting on rear guide tube 24 pushes bar 41 axially to the rear. The front end of sleeve 40 has an inside groove 43 defined at the front by a conical surface 44. Three balls 45 are housed in corresponding holes of hollow shaft 11 and have a diameter corresponding to the distance between the inside surface of shaft 11 and the base of groove 43 of sleeve 40. Each ball 45 rests on the outer surface of one of levers 26 of clamp 10 close to end 28 of the lever.

When sleeve 40 is freed from release mechanism 18, it tends to slide to the rear under the effect of the axial pressure of spring 42 so that its conical surface 44 pushes the end of each lever 26 radially inwards via the corresponding ball 45. As a result of the lever pivoting on flexible part 27, this force is transferred in multiplied form onto gripping jaw 20 of the lever and thus grips the tool shank very tightly and continuously during work. Persons skilled in the art will know that levers 26 of the clamp can be either rigid or slightly flexible in such a tightening mechanism. If they are rigid, the radial displacements of their ends are simply a little too short, and the same applies to the axial displacement of sleeve 40. In both cases, a high gripping force at the level of gripping jaws 20 is maintained continuously, even if the force of spring 42 is relatively low, as a result of the effect of the lever of the clamp and also as a result of the slight inclination of conical surface 44 in relation to axis 30. This slight inclination also means that the centrifugal force acting on levers 26 is not able to overcome the effect of spring 42. It must be noted in addition that the transfer of stresses via balls 45 is achieved with very little friction, and this also assists in maintaining a determined gripping force. However, these balls are not indispensable and they could be replaced by other transmission elements passing through shaft 11 and acting on levers 26.

Release mechanism 18 is designed to push sleeve 40 forwards against the force of spring 42 when the user causes control sleeve 6 to rotate on body 4 in the corresponding direction. It comprises a bushing 50 rotatably connected to control sleeve 6, one or more balls 51, in this case two balls disposed symmetrically in relation to the axis 30 of the handpiece, and a thrust collar 52 mounted to slide in sheath 16, and having at the front an inside shoulder 53 for axial support against an outer flange 54 of sleeve 40 when the latter is not rotating. Balls 51 are engaged in an annular outer groove 55 of collar 52. In addition, each ball 51 is engaged in a corresponding axial groove 56 of bushing 50 and in an inclined slit 57 (FIG. 6) of sheath 16. The course of each slit 57 is essentially helical to determine a certain axial displacement of ball 51, and its ends can be slightly bent to better define a stop position of the ball. In the preferred embodiment shown in FIG. 6, the rear end of each slit 57, corresponding to the retracted position of collar 52 and thus to a tightened state of clamp 10, is fitted with a flexible tab 58, the end of which has a protrusion, which holds ball 51 by engagement at the end of slit 57. This results in the rotatable control sleeve 6 being held elastically to prevent any inadvertent operation and indicates to the user that he/she is departing from the normal working position of the clamp. It should be noted that flexible tab 58 is simply made by milling an additional slit 59 into sheath 16.

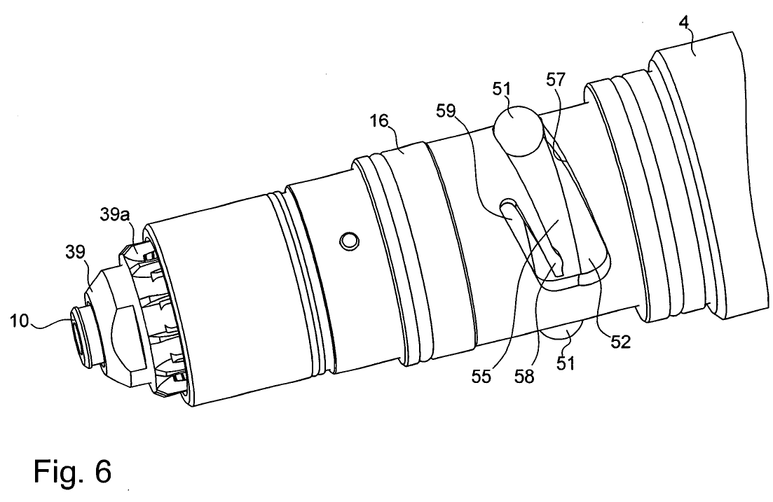

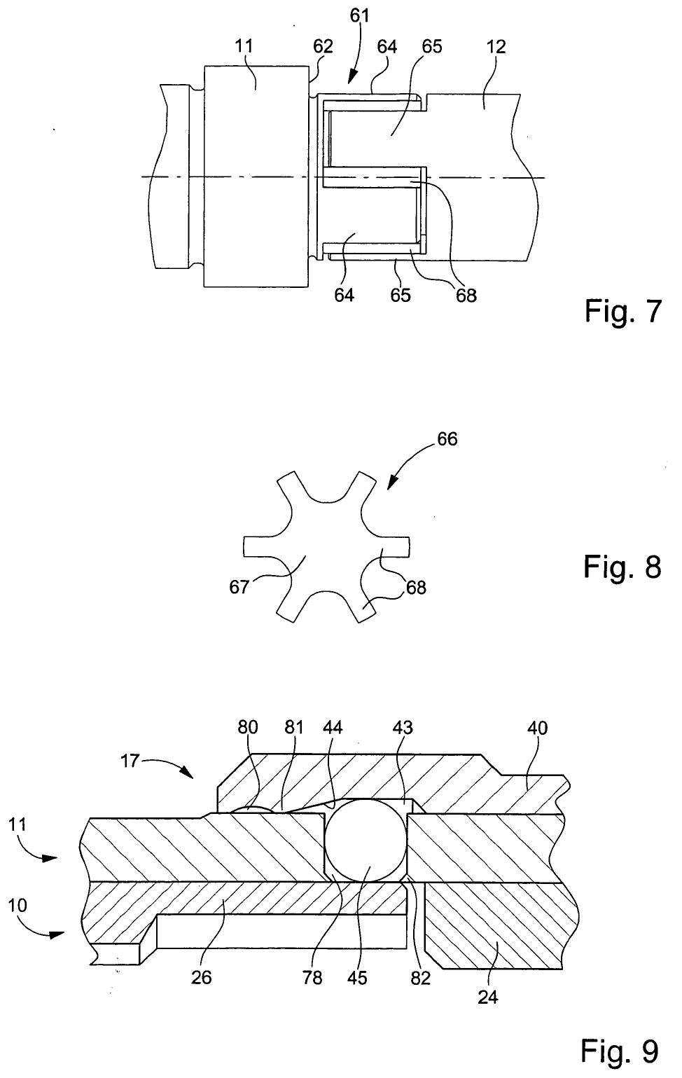

A remarkable aspect of the handpiece, shown in particular in FIG. 2, is the fact that the rotating part is supported by only three bearing arrangements, i.e. the front ball bearing 14, the central ball bearing 15 and a rear ball bearing 60, both of the two coaxial shafts 11 and 12 being supported by central bearing 15, inside which they are rotatably connected to one another by a positive coupling 61 shown most particularly in FIGS. 2, 7 and 8. The rear end of hollow shaft 11 has a shoulder 62, which abuts against an inner ring 63 of the bearing 15. It additionally has a set of teeth 64 inserted in ring 63, in this case three teeth distributed at 120 degrees from one another over the circumference. The front end of motor shaft 12 is inserted into the inner ring 63 of the bearing 15, preferably slidingly to be able to perform small axial displacements that can result from thermal expansions, axial play of the bearings and other tolerances. This end of shaft 12 also has teeth 65 extending axially between teeth 64 of the other shaft to ensure transmission of the torque in both directions between the two shafts. An intermediate piece 66, preferably made of synthetic material, has a cylindrical central body 67 and radial fins 68, which are interposed between adjacent teeth 64 and 65 to serve as cushioning. Moreover, intermediate piece 66 is axially prestressed against hollow shaft 11 by a compression spring 69 housed in shaft 12, the function of which will be outlined further below.

Front bearing 14 is prestressed by means of a diaphragm spring 70, which pushes an outer ring 72 of the bearing, which can slide in sheath 16, towards the rear. This axial prestress is transferred through bearing 14 and shaft 11 as far as the region of central bearing 15, where it is partly distributed over intermediate piece 66 and motor shaft 12 to an extent equal to the axial pressure of spring 69, and the rest is distributed in central bearing 15 in the form of a prestress which returns to sheath 16 via outer ring 72 of the bearing. The axial force that spring 69 exerts on shaft 12 clearly constitutes the axial prestress of rear bearing 60. As a result of the axial play of coupling 61 between the two shafts, this stress does not vary when the user exerts an axial pressure on the tool, since this pressure is completely absorbed by central bearing 15, the outer ring 72 of which is supported by the end of a tubular element 73 of the body 4 screwed into the rear end of sheath 16.

The construction described above has the same advantages as a classic construction with four bearings with respect to the absorption of axial stresses, but it is appreciably shorter and therefore enables the total length of the handpiece to be substantially reduced. This reduction in length has the great advantage of increasing the precision of handling by the operator, in particular by reducing the effect of stresses that cable 5 exerts on the rear end of the instrument.

Another particular advantage is that when adjacent ends of the two shafts 11 and 12 are supported and centred by the same ring 62, their concentricity is assured without any additional measure.

FIG. 9 shows a second embodiment of tightening mechanism 17, which allows appreciable simplifications over the first embodiment of the handpiece. Mechanism 17 differs from that described above mainly through the layout shown in FIG. 9 and by the omission of central spring 42 shown in FIG. 2. Release mechanism 18 thus acts as a control means for tightening and release.

In FIG. 9 one can see that the front end of sleeve 40 is modified simply by adding an annular groove 80 with a circular arc-shaped profile, this groove being separated from conical surface 44 by a short portion of cylindrical surface, which forms a radial projection 81 in relation to adjacent surfaces. In this case, each lever 26 of clamp 10 is preferably slightly flexible, which allows tightening mechanism 17 to function in the following manner.

FIG. 9 shows the release position, in which each ball 45 can run down to the bottom of groove 43 so that each lever 26 of clamp 10 can move apart until it rests against the inside surface of hollow shaft 11. Gripping jaws 20 of clamp 10 are then moved apart to the maximum distance and shank 3 of the tool can be inserted or removed.

To then tighten clamp 10, sleeve 40 is retracted by rotation of control sleeve 6, as in the preceding embodiment, but the axial displacement of sleeve 40 is greater, since it is performed until groove 80 is located on balls 45. Firstly, the movement of conical surface 44 on balls 45 pushes levers 26 towards the centre and causes them to flex when the gripping jaws of the clamp meet adequate resistance on the tool shank. As a result of this deflection, cylindrical projection 81 can pass over the balls and then groove 80 will engage on the balls and hold sliding sleeve 40 in place solely on the basis of the reaction force of levers 26 on balls 45.

The release is performed in essentially the same way as in the first embodiment, by a rotation of control sleeve 6 (FIG. 6) which causes collar 53 and the sleeve to advance to the position shown in FIG. 9.

The possibility of omitting central spring 42 shown in FIG. 2 provides quite important advantages. Firstly, the balance of the rotating part is better, since such a spring can never be perfectly centred in the hole containing it. The increase in weight also contributes to this. Secondly, the omission of this spring allows the reduction of axial forces exerted by release mechanism 18 in forward direction onto sliding sleeve 40 and consequently onto hollow shaft 11. These forces must then pass into the bearings supporting this shaft, in particular into front bearing 14, which is as small as possible and should not be subjected to too high an axial force. With the arrangement according to FIG. 9, the maximum axial force exerted on shaft 11 during release is the force necessary to cause balls 45 to exit from groove 80. Its value can be easily predetermined by the profile given to this groove.

It can be seen in FIG. 9 that a flange 82 or a series of equivalent lugs, is provided on the inside edge of cylindrical hole 78 containing ball 45 in order to hold this when clamp 10 is removed. Since this flange is not simple to produce, it may be replaced by a slight protrusion of rear tube 24 onto the outlet of hole 78 slightly shortening arms 26 of the clamp.

1. A powered handpiece for dental or surgical use comprising:
a hollow shaft, which is rotatable around a longitudinal axis and mounted by at least one bearing in a fixed tubular sheath;
a clamp mounted in a front end of the hollow shaft and having a central channel intended to receive a shank of a removable tool, the clamp having axial arms arranged around the longitudinal axis, each of which being provided with a gripping jaw in the central channel;
a tightening mechanism supported by the hollow shaft and arranged to exert a centripetal force on a supporting surface of each arm of the clamp to grip the tool shank between the gripping jaws of the clamp; and
a motor, the shaft of which is disposed in the extension of the hollow shaft, adjacent ends of these two shafts being rotatably connected by a positive coupling,
wherein the adjacent ends of the two shafts are both supported by a same inner ring of a central bearing.

2. The handpiece of claim 1, wherein the central bearing is mounted in said fixed tubular sheath.

3. The handpiece of claim 1, wherein the hollow shaft abuts axially against said inner ring, and wherein the end of the motor shaft is slidingly mounted in said inner ring.

4. The handpiece of claim 1, wherein said coupling is located inside said inner ring.

5. The handpiece of claim 1, wherein a rear end of the motor shaft is supported by a third bearing.

6. The handpiece of claim 5, wherein a first prestressing spring is arranged to apply a continuous axial stress on the hollow shaft via the bearing supporting this shaft at the front, and wherein a second prestressing spring is disposed between the two shafts in the region of the coupling and is fitted to transfer an axial stress from one to the other, which is lower than that of the first spring so that the difference between said axial stresses is transferred onto the central bearing.

7. The handpiece of claim 1, wherein a rear end of the hollow shaft has several axially protruding elements, which abut radially against said inner ring, and wherein a front end of the motor shaft has several axially protruding elements, which abut radially against said inner ring and which are interposed between said axially protruding elements of the hollow shaft.

8. The handpiece of claim 7, wherein an intermediate part is housed in said coupling and has radial fins interposed between said protruding elements of the two shafts.
